(19) United States
(12) Patent Application Publication
(10) Pub. No.: US 2015/0263958 A1
(43) Pub. Date: Sep. 17, 2015

(54) LOAD BALANCING APPARATUS AND METHOD

(71) Applicant: ELECTRONICS AND TELECOMMUNICATIONS RESEARCH INSTITUTE, Daejeon (KR)

(72) Inventors: Byung-Gyu LEE, Daejeon (KR); Sung-Ik JUN, Daejeon (KR); Baik-Song AN, Daejeon (KR); Byeong-Thaek OH, Daejeon (KR); Jin-Ho ON, Daejeon (KR)

(73) Assignee: ELECTRONICS AND TELECOMMUNICATIONS RESEARCH INSTITUTE, Daejeon (KR)

(21) Appl. No.: 14/660,062

(22) Filed: Mar. 17, 2015

(30) Foreign Application Priority Data
Mar. 17, 2014 (KR) 10-2014-0031012

(51) Int. Cl. H04L 12/803; H04L 12/863

(52) U.S. Cl. CPC H04L 47/125; H04L 47/622

(57) ABSTRACT

Disclosed herein is a load balancing apparatus and method. The load balancing apparatus includes a load characteristic analysis unit for analyzing characteristics of a required load upon executing a service requested by a client, a scheduling unit for scheduling the load based on the analyzed characteristics, and a load balancing unit for allocating the load stored in a queue corresponding to the analyzed characteristics to a server group into which servers are grouped for respective characteristics, performing service provisioning, and then allocating the load to an available server.

### CROSS REFERENCE TO RELATED APPLICATION

This application claims the benefit of Korean Patent Application No. 10-2014-0031012 filed Mar. 17, 2014, which is hereby incorporated by reference in its entirety into this application.

### BACKGROUND OF THE INVENTION

1. Technical Field

The present invention generally relates to a load balancing apparatus and method and, more particularly, to a load balancing apparatus and method, which analyze the characteristics of a required load when a service requested by a client is executed, and distribute the load to an available server.

2. Description of the Related Art

With the development of networks such as the Internet, a large number of services have been created and are available over the Internet at the present time. Therefore, the number of services by which a server host performs a task or stores data over a network at the request of a client has increased. Due to an increase in the number of services, the need for load balancing techniques that prevent service requests from concentrating on a specific server was raised. Load balancing techniques that are used in an existing load balancing apparatus include a method of sequentially distributing the requests of clients to a plurality of servers and a method of distributing the requests of clients to randomly selected servers. In addition, a method of assigning weights to servers having difference performances and allocating the requests of clients depending on the weights, a method of determining whether to allocate the requests of clients depending on the current availability of each server, etc. are present.

Most of the above-described methods are configured such that the purpose of load balancing is to maintain a service response time at a constant time by preventing service requests from concentrating on a specific server. Further, the above-described methods greatly increase the power consumption of a server due to an increase in the performance of a Central Processing Unit (CPU) together with an increase in the performance of hardware. Therefore, a problem arises in that maintenance costs including the power consumption of clusters for providing services are increased. In order to solve this problem, low-power servers having relatively low CPU performance have been commercialized.

When load balancing is performed using the above methods in a cluster environment composed of a plurality of different servers, there is a disadvantage in that it is difficult to actually distribute loads in correspondence with various services. Further, there is a disadvantage in that low-power servers introduced to reduce power consumption cannot be properly utilized, and in that when services requiring high performance are allocated to lower-power servers having CPUs, the performance of which is relatively low, it is impossible to cope with a response speed required by clients.

In relation to this, Korean Patent Application Publication No. 2009-0070030 discloses technology entitled “Method of Admission Control for Adaptive Load Sharing in Heterogeneous Wireless Networks Environment”.

### SUMMARY OF THE INVENTION

Accordingly, the present invention has been made keeping in mind the above problems occurring in the prior art, and an object of the present invention is to provide a load balancing apparatus and method, which determine and analyze whether a load has CPU-bound characteristics in which the load predominantly uses a CPU or Input/Output(I/O)-bound characteristics in which the load predominantly uses an I/O device, upon executing a service requested by a client.

Another object of the present invention is to provide a load balancing apparatus and method, which allocate a load stored in a queue corresponding to analyzed characteristics to a server group into which servers are grouped depending on respective characteristics, perform service provisioning, and allocate the load to an available server.

In accordance with an aspect of the present invention to accomplish the above objects, there is provided a load balancing apparatus, including a load characteristic analysis unit for analyzing characteristics of a required load upon executing a service requested by a client; a scheduling unit for scheduling the load based on the analyzed characteristics; and a load balancing unit for allocating the load stored in a queue corresponding to the analyzed characteristics to a server group into which servers are grouped for respective characteristics, performing service provisioning, and then allocating the load to an available server.

The load characteristics may be divided into Central Processing Unit (CPU)-bound characteristics in which the load predominantly uses a CPU and Input/Output (I/O)-bound characteristics in which the load predominantly uses an I/O device.

The load characteristic analysis unit may include a characteristic extraction unit for analyzing the load and extracting characteristic information from the load; a profile unit for generating profile information related to the extracted characteristic information; and a storage unit for storing the generated profile information.

The profile unit may determine whether profile information related to the extracted characteristic information is present, and if it is determined that the generated profile information is stored in the storage unit, transfer the profile information stored in the storage unit to the scheduling unit.

The scheduling unit may store the load in a queue suitable for characteristics of the load using a scheduling algorithm based on characteristic information analyzed by the load characteristic analysis unit and generated profile information.

The queue may be implemented as any one of a CPU-bound queue and an I/O-bound queue.

The load balancing unit may include a first distribution unit for allocating a load stored in the CPU-bound queue to any one of servers belonging to a first server group; and a second distribution unit for allocating a load stored in the I/O-bound queue to any one of servers belonging to a second server group.

The first distribution unit may include a first group allocation unit for allocating the load stored in the CPU-bound queue to the first server group into which servers are grouped for respective characteristics; a first provisioning unit for performing service provisioning on the load allocated to the first server group; and a first server allocation unit for allocating the load to any one of servers belonging to the first server group.

The second distribution unit may include a second group allocation unit for allocating the load stored in the I/O-bound queue to the second server group into which servers are grouped for respective characteristics; a second provisioning unit for performing service provisioning on the load allocated to the second server group; and a second server allocation unit for allocating the load to any one of servers belonging to the second server group.

The second server group may be a group of servers operating at lower power.

In accordance with another aspect of the present invention to accomplish the above objects, there is provided a load balancing method, including analyzing, by a load characteristic analysis unit, characteristics of a required load upon executing a service requested by a client; scheduling, by a scheduling unit, the load based on the analyzed characteristics; and allocating, by a load balancing unit, the load stored in a queue corresponding to the analyzed characteristics to a server group into which servers are grouped for respective characteristics, performing service provisioning, and then allocating the load to an available server.

Analyzing the characteristics of the required load upon executing the service requested by the client may include analyzing the load and extracting characteristic information from the load; generating profile information related to the extracted characteristic information; and storing the generated profile information.

Generating the profile information related to the extracted characteristic information may include determining whether profile information related to the extracted characteristic information is present; and if it is determined that the generated profile information is stored, transferring the stored profile information to the scheduling unit.

Allocating the load stored in the queue, performing service provisioning, and then allocating the load to the available server may include allocating a load stored in a CPU-bound queue to any one of servers belonging to a first server group; and allocating a load stored in an I/O-bound queue to any one of servers belonging to a second server group.

Allocating the load stored in the CPU-bound queue to any one of the servers belonging to the first server group may include allocating the load stored in the CPU-bound queue to the first server group into which servers are grouped for respective characteristics; performing service provisioning on the load allocated to the first server group; and allocating the load to any one of servers belonging to the first server group.

Allocating the load stored in the I/O-bound queue to any one of the servers belonging to the second server group may include allocating the load stored in the I/O-bound queue to the second server group into which servers are grouped for respective characteristics; performing service provisioning on the load allocated to the second server group; and allocating the load to any one of servers belonging to the second server group.

The load balancing apparatus and method according to the present invention having the above configuration is advantageous in that they may determine and analyze whether a load has CPU-bound characteristics in which the load predominantly uses a CPU or I/O-bound characteristics in which the load predominantly uses an I/O device, upon executing a service requested by a client, and may allocate the load to an available server based on the analyzed load characteristics, thus guaranteeing system performance and stability, with the result that reliable services may be provided to users.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of a load balancing apparatus according to the present invention;

FIG. 2 is a diagram showing the detailed configuration of a load characteristic analysis unit employed in the load balancing apparatus according to the present invention;

FIG. 3 is a diagram showing the detailed configuration of a load balancing unit employed in the load balancing apparatus according to the present invention;

FIG. 4 is a diagram showing the detailed configuration of the first distribution unit of the load balancing unit according to the present invention;

FIG. 5 is a diagram showing the detailed configuration of the second distribution unit of the load balancing unit according to the present invention;

FIG. 6 is a flowchart showing the sequence of a load balancing method according to the present invention;

FIG. 7 is a flowchart showing the sequence of a method of analyzing load characteristics in the load balancing method according to the present invention;

FIG. 8 is a flowchart showing the sequence of a method of distributing a load stored in a CPU-bound queue in the load balancing method according to the present invention; and

FIG. 9 is a flowchart showing the sequence of a method of distributing a load stored in an I/O-bound queue in the load balancing method according to the present invention.

### DESCRIPTION OF THE PREFERRED EMBODIMENTS

Embodiments of the present invention are described with reference to the accompanying drawings in order to describe the present invention in detail so that those having ordinary knowledge in the technical field to which the present invention pertains can easily practice the present invention. It should be noted that the same reference numerals are used to designate the same or similar elements throughout the drawings. In the following description of the present invention, detailed descriptions of known functions and configurations that are deemed to make the gist of the present invention obscure will be omitted.

Hereinafter, a load balancing apparatus and method according to embodiments of the present invention will be described in detail with reference to the attached drawings.

First, a system according to the present invention includes a plurality of clients for requesting services from a server that provides services; a network for connecting individual clients to each other; and the server for providing the services requested by the clients.

Each client that requests a service may be implemented as any one of a mobile device such as a smart phone, a notebook computer, and a desktop computer, and may request a service from the server over the network. Further, the server allocates a load required for service execution to one of internal nodes. In this case, the server may be either a node having a single hardware specification or a node having various hardware specifications.

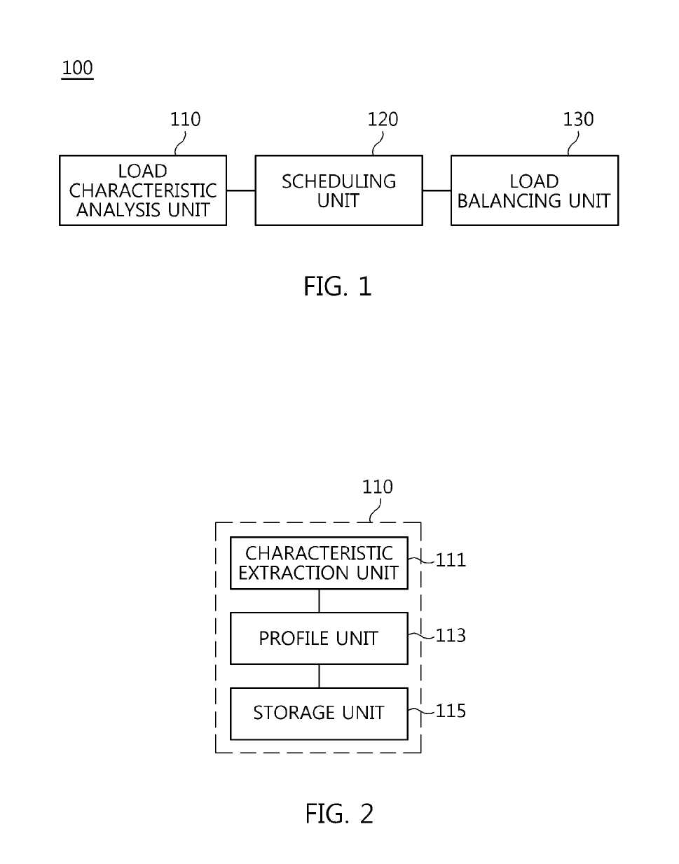

FIG. 1 is a diagram showing the configuration of a load balancing apparatus according to the present invention.

Referring to FIG. 1, a load balancing apparatus 100 according to the present invention includes a load characteristic analysis unit 110, a scheduling unit 120, and a load balancing unit 130.

The load characteristic analysis unit 110 analyzes the characteristics of a required load, upon executing a service requested by a client. The load characteristic analysis unit 110 determines whether a load has CPU-bound characteristics in which the load predominantly uses a CPU, or I/O-bound characteristics in which the load predominantly uses an I/O device.

The scheduling unit 120 schedules the load based on the analyzed characteristics. The scheduling unit 120 stores the load in a queue corresponding to the characteristics of the load using a scheduling algorithm based on the characteristic information, analyzed by the load characteristic analysis unit 110, and generated profile information. Here, the queue may be composed of a CPU-bound queue and an I/O-bound queue.

The load balancing unit 130 allocates the load, stored in the queue corresponding to the analyzed characteristics, to a server group into which servers are grouped for respective characteristics, performs service provisioning, and allocates the load to an available server. That is, the load balancing unit 130 allocates the load stored in the CPU-bound queue or the load stored in the I/O-bound queue to an available server.

FIG. 2 is a diagram showing the detailed configuration of the load characteristic analysis unit employed in the load balancing apparatus according to the present invention.

Referring to FIG. 2, the load characteristic analysis unit 110 according to the present invention analyzes the characteristics of a required load, upon executing a service requested by a client.

For this, the load characteristic analysis unit 110 includes a characteristic extraction unit 111, a profile unit 113, and a storage unit 115.

The characteristic extraction unit 111 analyzes a load and extracts characteristic information from the load. That is, the characteristic extraction unit 111 extracts characteristic information indicating whether the load has CPU-bound characteristic information in which the load predominantly uses a CPU, or I/O-bound characteristic information in which the load predominantly uses an I/O device.

The profile unit 113 generates profile information related to the extracted characteristic information. The profile unit 113 determines whether profile information related to the extracted characteristic information is present. If it is determined that the generated profile information is stored in the storage unit 115, the corresponding profile information stored in the storage unit 115 is transferred to the scheduling unit 120.

The storage unit 115 stores the generated profile information.

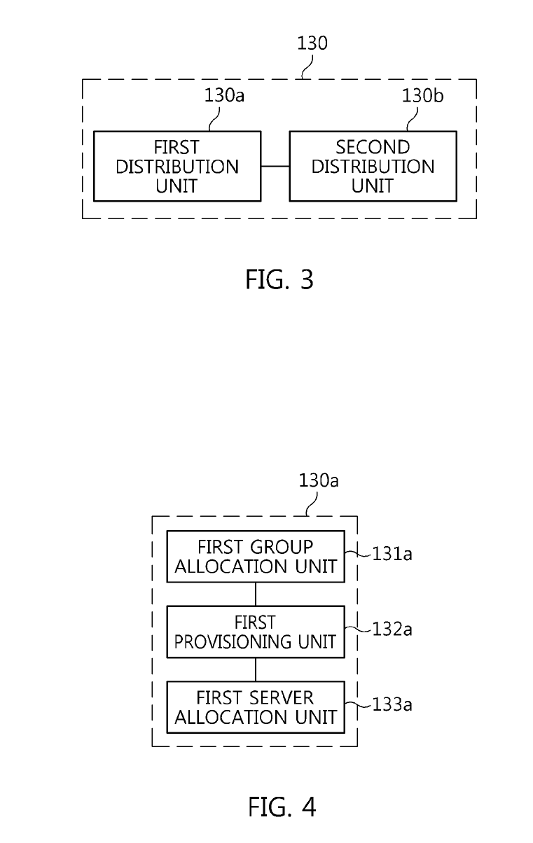

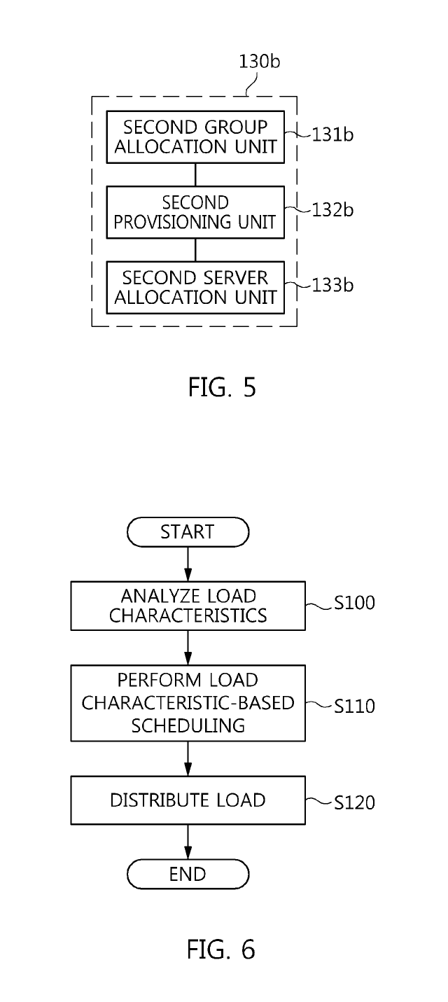

FIG. 3 is a diagram showing the detailed configuration of the load balancing unit employed in the load balancing apparatus according to the present invention, FIG. 4 is a diagram showing the detailed configuration of the first distribution unit of the load balancing unit according to the present invention, and FIG. 5 is a diagram showing the detailed configuration of the second distribution unit of the load balancing unit according to the present invention.

Referring to FIG. 3, the load balancing unit 130 according to the present invention allocates a load stored in a queue corresponding to analyzed characteristics to a server group into which servers are grouped for respective characteristics, performs service provisioning, and then allocates the load to an available server. In this case, the server group is divided into a group of servers having excellent CPU efficiency depending on CPU-bound characteristics and a group of servers having excellent I/O efficiency, that is, servers operating at low power, depending on I/O-bound characteristics.

For this, the load balancing unit 130 includes a first distribution unit 130a and a second distribution unit 130b.

The first distribution unit 130a allocates a load stored in a CPU-bound queue to any one of servers belonging to a first server group. Here, the first server group is a group of servers having excellent CPU efficiency depending on the CPU-bound characteristics.

For this, as shown in FIG. 4, the first distribution unit 130a includes a first group allocation unit 131a, a first provisioning unit 132a, and a first server allocation unit 133a.

The first group allocation unit 131a allocates a load stored in the CPU-bound queue to a first server group into which servers are grouped for respective characteristics.

The first provisioning unit 132a performs service provisioning on the load allocated to the first server group. Here, service provisioning denotes a procedure and behavior for preparing necessary knowledge and supplying the knowledge in response to a request so as to find an optimal object from among a plurality of objects based on lexical meanings. Therefore, the first provisioning unit 132a functions to allocate the load allocated to the first server group and to prepare the operation of a service.

The first server allocation unit 133a allocates the load to any one of servers belonging to the first server group.

The second distribution unit 130b allocates a load stored in the I/O-bound queue to any one of servers belonging to the second server group. In this case, the second server group is a group of servers having excellent I/O efficiency, that is, servers operating at low power, depending on I/O-bound characteristics.

For this, as shown in FIG. 5, the second distribution unit 130b includes a second group allocation unit 131b, a second provisioning unit 132b, and a second server allocation unit 133b.

The second group allocation unit 131b allocates a load stored in the I/O-bound queue to a second server group into which servers are grouped for respective characteristics.

The second provisioning unit 132b performs service provisioning on the load allocated to the second server group. Similarly to the first provisioning unit 132a, the second provisioning unit 132b functions to allocate a load, allocated to the second server group, and prepare the operation of a service.

The second server allocation unit 133b allocates the load to any one of servers belonging to the second server group.

FIG. 6 is a flowchart showing the sequence of a load balancing method according to the present invention.

Referring to FIG. 6, the load balancing method according to the present invention uses the above-described load balancing apparatus 100, and thus a repeated description thereof will be omitted.

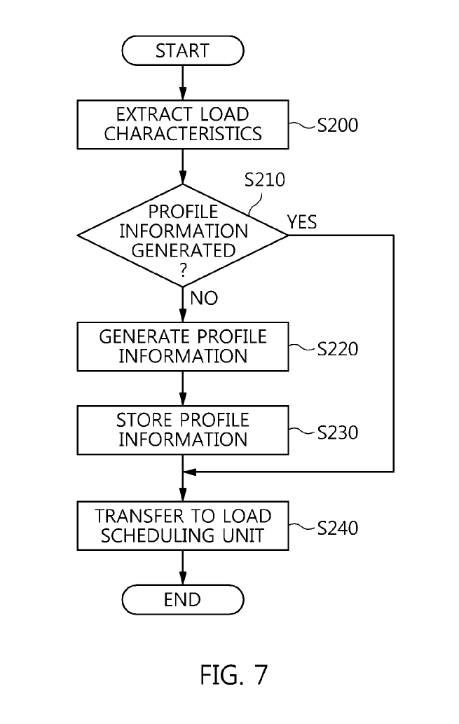

First, when a service requested by the client is executed, the characteristics of a required load are analyzed at step S100. At step S100, the load characteristics are analyzed as any one of CPU-bound characteristics in which the load predominantly uses a CPU and I/O-bound characteristics in which the load predominantly uses an I/O device. Step S100 will be described in detail later with reference to FIG. 7.

Then, the load is scheduled based on the analyzed characteristics at step S110.

Thereafter, the load stored in a queue corresponding to the analyzed characteristics is allocated to a server group into which servers are grouped for respective characteristics, and service provisioning is performed, so that the load is allocated to an available server at step S120. At step S120, the load stored in the CPU-bound queue or the load stored in the I/O-bound queue is allocated to an available server.

FIG. 7 is a flowchart showing the sequence of a method of analyzing load characteristics in the load balancing method according to the present invention.

Referring to FIG. 7, the method of analyzing load characteristics in the load balancing method according to the present invention is intended to analyze the characteristics of a required load upon executing a service requested by a client. First, characteristic information is extracted by analyzing the load at step S200. At step S200, characteristic information indicating whether the load has CPU-bound characteristic information or I/O-bound characteristic information is extracted.

Thereafter, it is determined whether the profile information of the load has been generated at step S210. If the profile information of the load is stored in the storage unit at step S210, the profile information stored in the storage unit is transferred to the scheduling unit 120 at step S240, whereas if the profile information of the load is not stored in the storage unit, the process proceeds to step S220.

Profile information related to the extracted characteristic information is generated at step S220.

The generated profile information is stored at step S230.

The stored profile information is transferred to the scheduling unit 120 at step S240. After step S240, the scheduling unit 120 stores the load in the CPU-bound queue or the I/O-bound queue in conformity with the characteristics of the load using a scheduling algorithm based on the extracted characteristic information and the profile information.

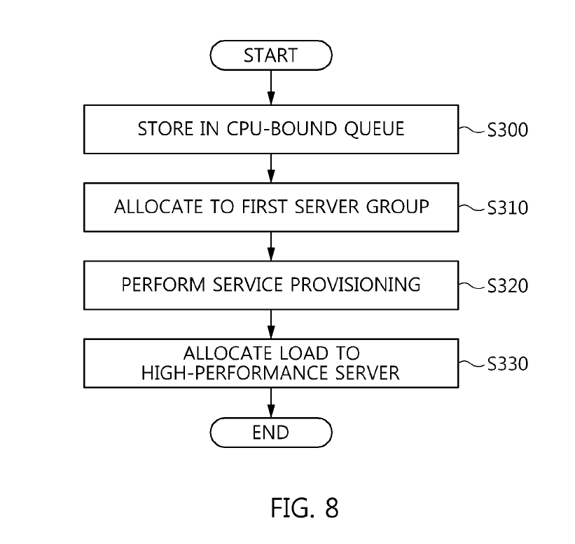

FIG. 8 is a flowchart showing the sequence of a method of distributing a load stored in a CPU-bound queue in the load balancing method according to the present invention.

Referring to FIG. 8, the method of distributing a load stored in the CPU-bound queue in the load balancing method according to the present invention will be described. First, a load having CPU-bound characteristics is stored in the CPU-bound queue at step S300.

Then, the load stored in the CPU-bound queue is allocated to a first server group into which servers are grouped for respective characteristics at step S310. In this case, the first server group is a group of servers having excellent CPU efficiency depending on the CPU-bound characteristics.

Thereafter, service provisioning is performed on the load allocated to the first server group at step S320.

The load is allocated to any one high-performance server belonging to the first server group at step S330.

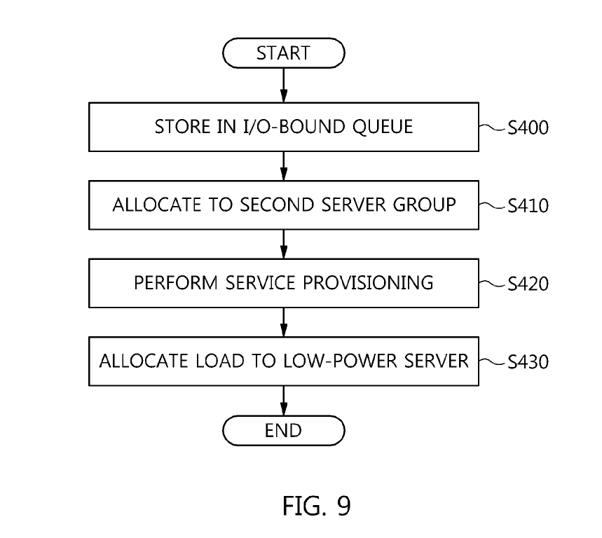

FIG. 9 is a flowchart showing the sequence of a method of distributing a load stored in an I/O-bound queue in the load balancing method according to the present invention.

Referring to FIG. 9, the method of distributing the load stored in the I/O-bound queue in the load balancing method according to the present invention will be descried. First, a load having I/O-bound characteristics is stored in the I/O-bound queue at step S400.

Then, the load stored in the I/O-bound queue is allocated to a second server group into which servers are grouped for respective characteristics at step S410. In this case, the second server group is a group of servers having excellent I/O efficiency depending on I/O-bound characteristics.

Service provisioning is performed on the load allocated to the second server group at step S420.

Then, the load is allocated to any one low-power server belonging to the second server group at step S430.

In this way, the load balancing apparatus and method according to the present invention may determine and analyze whether a load has CPU-bound characteristics in which the load predominantly uses a CPU or I/O-bound characteristics in which the load predominantly uses an I/O device, upon executing a service requested by a client, and may allocate the load to an available server based on the analyzed load characteristics, thus guaranteeing system performance and stability, with the result that reliable services may be provided to users.

As described above, although preferred embodiments of the present invention have been described, those skilled in the art will appreciate that the present invention may be modified in various forms, and various modifications and changes may be practiced without departing from the spirit and scope of the accompanying claims.

What is claimed is:

1. A load balancing apparatus, comprising:
a load characteristic analysis unit for analyzing characteristics of a required load upon executing a service requested by a client;
a scheduling unit for scheduling the load based on the analyzed characteristics; and
a load balancing unit for allocating the load stored in a queue corresponding to the analyzed characteristics to a server group into which servers are grouped for respective characteristics, performing service provisioning, and then allocating the load to an available server.

2. The load balancing apparatus of claim 1, wherein the load characteristics are divided into Central Processing Unit (CPU)-bound characteristics in which the load predominantly uses a CPU and Input/Output (I/O)-bound characteristics in which the load predominantly uses an I/O device.

3. The load balancing apparatus of claim 1, wherein the load characteristic analysis unit comprises:
a characteristic extraction unit for analyzing the load and extracting characteristic information from the load;
a profile unit for generating profile information related to the extracted characteristic information; and
a storage unit for storing the generated profile information.

4. The load balancing apparatus of claim 3, wherein the profile unit determines whether profile information related to the extracted characteristic information is present, and if it is determined that the generated profile information is stored in the storage unit, transfers the profile information stored in the storage unit to the scheduling unit.

5. The load balancing apparatus of claim 1, wherein the scheduling unit stores the load in a queue suitable for characteristics of the load using a scheduling algorithm based on characteristic information analyzed by the load characteristic analysis unit and generated profile information.

6. The load balancing apparatus of claim 1, wherein the queue is implemented as any one of a CPU-bound queue and an I/O-bound queue.

7. The load balancing apparatus of claim 6, wherein the load balancing unit comprises:
a first distribution unit for allocating a load stored in the CPU-bound queue to any one of servers belonging to a first server group; and
a second distribution unit for allocating a load stored in the I/O-bound queue to any one of servers belonging to a second server group.

8. The load balancing apparatus of claim 7, wherein the first distribution unit comprises:
a first group allocation unit for allocating the load stored in the CPU-bound queue to the first server group into which servers are grouped for respective characteristics;
a first provisioning unit for performing service provisioning on the load allocated to the first server group; and
a first server allocation unit for allocating the load to any one of servers belonging to the first server group.

9. The load balancing apparatus of claim 7, wherein the second distribution unit comprises:
a second group allocation unit for allocating the load stored in the I/O-bound queue to the second server group into which servers are grouped for respective characteristics;
a second provisioning unit for performing service provisioning on the load allocated to the second server group; and
a second server allocation unit for allocating the load to any one of servers belonging to the second server group.

10. The load balancing apparatus of claim 7, wherein the second server group is a group of servers operating at lower power.

11. A load balancing method, comprising:
analyzing, by a load characteristic analysis unit, characteristics of a required load upon executing a service requested by a client;
scheduling, by a scheduling unit, the load based on the analyzed characteristics; and
allocating, by a load balancing unit, the load stored in a queue corresponding to the analyzed characteristics to a server group into which servers are grouped for respective characteristics, performing service provisioning, and then allocating the load to an available server.

12. The load balancing method of claim 11, wherein analyzing the characteristics of the required load upon executing the service requested by the client comprises:
analyzing the load and extracting characteristic information from the load;
generating profile information related to the extracted characteristic information; and
storing the generated profile information.

13. The load balancing method of claim 11, wherein generating the profile information related to the extracted characteristic information comprises:
determining whether profile information related to the extracted characteristic information is present; and
if it is determined that the generated profile information is stored, transferring the stored profile information to the scheduling unit.

14. The load balancing method of claim 11, wherein allocating the load stored in the queue, performing service provisioning, and then allocating the load to the available server comprises:
allocating a load stored in a CPU-bound queue to any one of servers belonging to a first server group; and
allocating a load stored in an I/O-bound queue to any one of servers belonging to a second server group.

15. The load balancing method of claim 14, wherein allocating the load stored in the CPU-bound queue to any one of the servers belonging to the first server group comprises:
allocating the load stored in the CPU-bound queue to the first server group into which servers are grouped for respective characteristics;
performing service provisioning on the load allocated to the first server group; and
allocating the load to any one of servers belonging to the first server group.

16. The load balancing method of claim 14, wherein allocating the load stored in the I/O-bound queue to any one of the servers belonging to the second server group comprises:
allocating the load stored in the I/O-bound queue to the second server group into which servers are grouped for respective characteristics;
performing service provisioning on the load allocated to the second server group; and
allocating the load to any one of servers belonging to the second server group.
